(19) United States
(12) Patent Application Publication
(10) Pub. No.: US 2019/0295409 A1
(43) Pub. Date: Sep. 26, 2019

(54) TRAFFIC INFORMATION PROVIDING SYSTEM AND TRAFFIC INFORMATION PROVIDING METHOD

(71) Applicant: TOYOTA JIDOSHA KABUSHIKI KAISHA, Toyota-shi (JP)

(72) Inventor: Makoto AKAHANE, Nagoya-shi (JP)

(73) Assignee: TOYOTA JIDOSHA KABUSHIKI KAISHA, Toyota-shi (JP)

(21) Appl. No.: 16/244,335

(22) Filed: Jan. 10, 2019

(30) Foreign Application Priority Data
Mar. 20, 2018 (JP) 2018-052612

(51) Int. Cl. G08G 1/01; G08G 1/09; G06Q 50/00

(52) U.S. Cl. CPC G08G 1/012; G06Q 50/01; G08G 1/093; G08G 1/0141

(57) ABSTRACT

A post extracting section extracts a post including traffic information from among posts accumulated in an SNS server. A location information requesting section requests, from a first in-vehicle unit associated with a poster of the extracted post, location information of the poster. A location information obtaining section obtains the location information of the poster transmitted from the first in-vehicle unit in response to the request. A location information setting section associates the obtained location information of the poster with the traffic information included in the post. A traffic information delivering section delivers the traffic information, with which the location information of the poster is associated, either to the first in-vehicle unit or a second in-vehicle unit.

### BACKGROUND

The following description relates to a traffic information providing system and a traffic information providing method. The traffic information providing system and traffic information providing method extract traffic information from posts uploaded to a social networking service (SNS) server and provide the extracted traffic information to users.

One example of such conventional traffic information providing systems is disclosed in Japanese Laid-Open Patent Publication No. 2013-50916. In this system, the user sets search conditions for posts, including the posters' locations, and extracts posts corresponding to the set search conditions from the database of the server of a social networking service (SNS). The system is designed to provide the content of the post to the user while associating the content of the post with the poster's location when he/she uploaded the post.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The following description provides a traffic information providing system and a traffic information providing method capable of identifying a position where a post including traffic information is uploaded with high versatility.

Examples of the present disclosure will now be described.

### EXAMPLE 1

A traffic information providing system including a processor is provided. The processor includes a post extracting section configured to extract a post including traffic information from among posts accumulated in an SNS server, a location information requesting section configured to request, from a first in-vehicle unit associated with a poster of the post extracted by the post extracting section, location information of the poster, a location information obtaining section configured to obtain the location information of posters transmitted from the first in-vehicle unit in response to a request from the location information requesting section, a location information setting section configured to associate the location information of the poster obtained by the location information obtaining section with the traffic information included in the post, and a traffic information delivering section configured to deliver the traffic information, with which the location information of the poster is associated by the location information setting section, either to the first in-vehicle unit or a second in-vehicle unit different from the first in-vehicle unit.

A program that causes a processor to perform a traffic information providing process of providing traffic information is also provided. The traffic information providing process includes: extracting a post including traffic information from posts accumulated in an SNS server, a first in-vehicle unit being associated with a poster of the extracted post; associating a first in-vehicle unit with a poster of the extracted post; requesting location information of the poster from the first in-vehicle unit; obtaining the location information of the poster transmitted from the first in-vehicle unit In response to the request for the location information of the poster; associating the obtained location information of the poster with the traffic information included in the post; and delivering the traffic information, with which the location information of the poster is associated, either to the first in-vehicle unit or a second in-vehicle unit different from the first in-vehicle unit.

With this configuration, even if a post does not include the poster's location information, the location where a post including traffic information is uploaded is identified based on the poster's location information received from the first in-vehicle unit associated with the poster.

A post does not necessarily include the location of the poster. Also, even if the post includes the position of the poster, the position of the poster may not be disclosed to a third party from the viewpoint of protection of privacy. Therefore, it is sometimes difficult to identify the position where a post was uploaded based on the position of the poster associated with the post, as in the case of the system disclosed in the above document. The above-described configuration reduces this difficulty.

### EXAMPLE 2

In the traffic information providing system of Example 1, the traffic information delivering section is configured to deliver the traffic information included in the post either to the first in-vehicle unit or the second in-vehicle unit based on verification of a condition that the number of posts associated with the same point is greater than or equal to a predetermined threshold value.

With this configuration, it is possible to identify the location information uploaded with high reliability.

### EXAMPLE 3

In the traffic information providing system of Example 1 or 2, the first in-vehicle unit and the second in-vehicle unit are mounted in different vehicles.

With this configuration, the vehicle that is the transmission source of the poster's location information is different from the vehicle that is the delivery destination of the traffic information with which the location information is associated. This increases the versatility of delivery of the post including the traffic information to the user.

### EXAMPLE 4

The traffic information providing system of any of Examples 1 to 3 further includes a memory section configured to store a user ID of an SNS and a vehicle ID while associating the IDs with each other. The location information requesting section is configured to: based on a user ID related to the poster of the post extracted by the post extracting section, read out a corresponding vehicle ID by referring to the memory section; and, based on the read out vehicle ID, identify the first in-vehicle unit that is a source of transmission of the location information of the poster.

With this configuration, since the user ID of the SNS is associated with the vehicle ID, the vehicle on which the poster of the post is riding is identified. This allows the vehicle location information to be detected as the location information about the poster by means of the location sensor mounted on the vehicle.

### EXAMPLE 5

A traffic information providing method is provided that performs the various processes described in Examples 1 to 4.

### EXAMPLE 6

A non-transitory computer readable memory medium is provided that stores a program that causes a processing device to perform the various processes described in Examples 1 to 4.

Other features and aspects will be apparent from the following detailed description, the drawings, and the claims.

### BRIEF DESCRIPTION OF THE DRAWINGS

FIG. 1 is a block diagram schematically showing the configuration of a traffic information providing system according to an embodiment of the present disclosure.

FIG. 2 is a schematic diagram showing one example of data contents registered in a database of an SNS server in the traffic information providing system of FIG. 1.

FIG. 3 is a schematic diagram showing one example of data contents registered in a user information database in the traffic information providing system of FIG. 1.

FIG. 4A is a schematic diagram showing one example of data contents registered in an accident information database in the traffic information providing system of FIG. 1.

FIG. 4B is a schematic diagram showing one example of posting locations of posts registered in the accident information database in the traffic information providing system of FIG. 1.

FIG. 5 is a sequence chart showing the flow of a traffic information delivery process in the traffic information providing system of FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

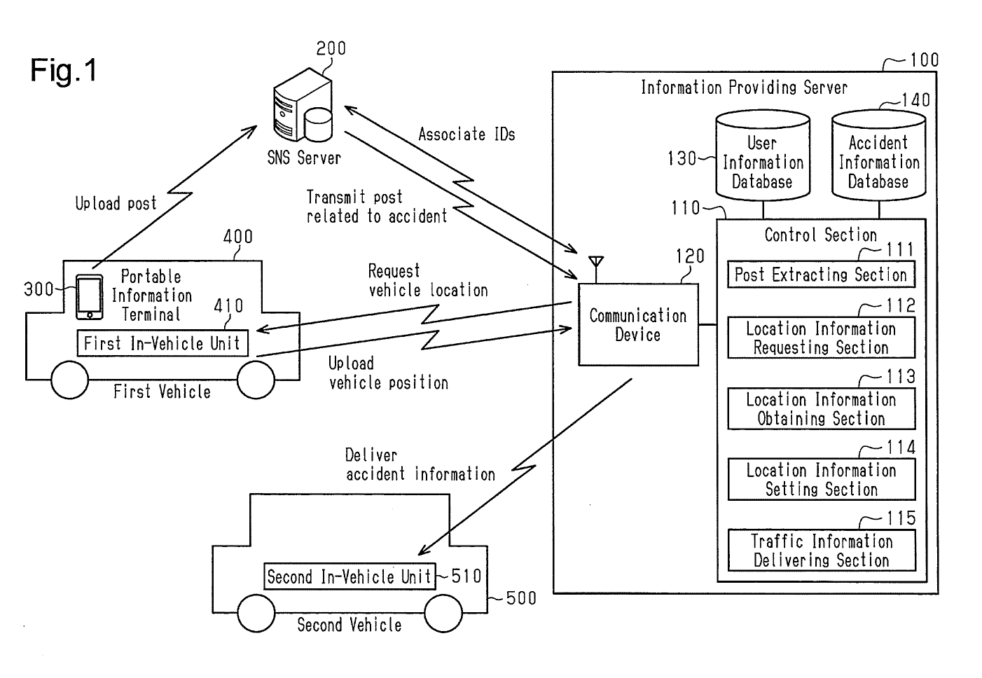

A traffic information providing system according to an embodiment will be described with reference to FIGS. 1 to 5.

The traffic information providing system of the present embodiment includes an information providing server 100 that manages travelling information about multiple vehicles. The information providing server 100 extracts accident information (traffic information) from a post uploaded to an SNS server 200 from a first vehicle and delivers the extracted accident information to a second vehicle different from the first vehicle.

Specifically, as shown in FIG. 1, the information providing server 100 includes a control section 110, a communication device 120, a user information database 130, and an accident information database 140.

The control section 110 includes a processor that uses, when delivering accident information, a post extracting section 111, a location information requesting section 112, a location information obtaining section 113, a location information setting section 114, and a traffic information delivering section 115.

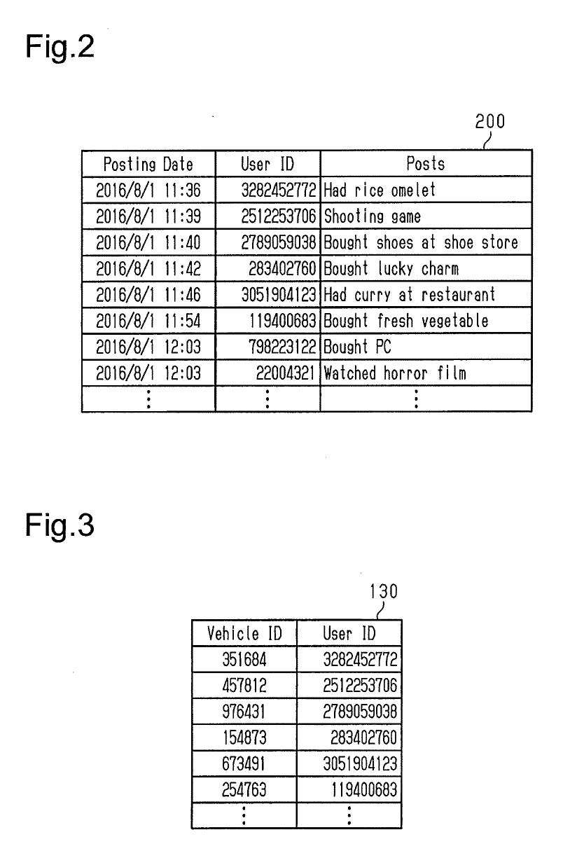

The post extracting section 111 extracts a post including accident information from the posts accumulated in the SNS server 200. More specifically, as shown in FIG. 2, the SNS server 200 accumulates posts that are transmitted from a portable information terminal 300 through text input operation on an application installed in the portable information terminal 300. At this time, the portable information terminal 300 associates the user ID entered when the user logs in to the application related to the social networking service (SNS) with the date of post upload and the content of the post, and accumulates the ID in the SNS server 200. Then, the post extracting section 111 extracts posts including keywords related to an accident by performing text analysis on the posts accumulated in the SNS server 200.

The location information requesting section 112 requests the poster's location information from a first in-vehicle unit 410 associated with the poster of the post extracted by the post extracting section 111. More specifically, the location information requesting section 112 reads from the SNS server 200 the user ID associated with the post extracted by the post extracting section 111. Further, the location information requesting section 112 extracts the vehicle ID corresponding to the user ID read from the SNS server 200 by referring to the user information database 130. As shown in FIG. 3, the user information database 130 is a memory section that stores vehicle IDs and user IDs, while associating these with each other. The vehicle IDs are used to manage the use of services provided from the information providing server 100 through in-vehicle units, and the user IDs are used to manage the use of applications related to the SNS. Therefore, when a service is used, the user possessing the portable information terminal 300 is the same as the user riding the first vehicle 400. Then, based on the vehicle ID extracted as described above, the location information requesting section 112 identifies the first in-vehicle unit 410 mounted in the first vehicle 400 as an in-vehicle unit from which the location information about the poster is requested (transmission source). The location information requesting section 112 receives the location information about the first vehicle 400 from the first in-vehicle unit 410 identified as described above based on the Global Positioning System (GPS) device mounted as the location sensor in the first vehicle 400.

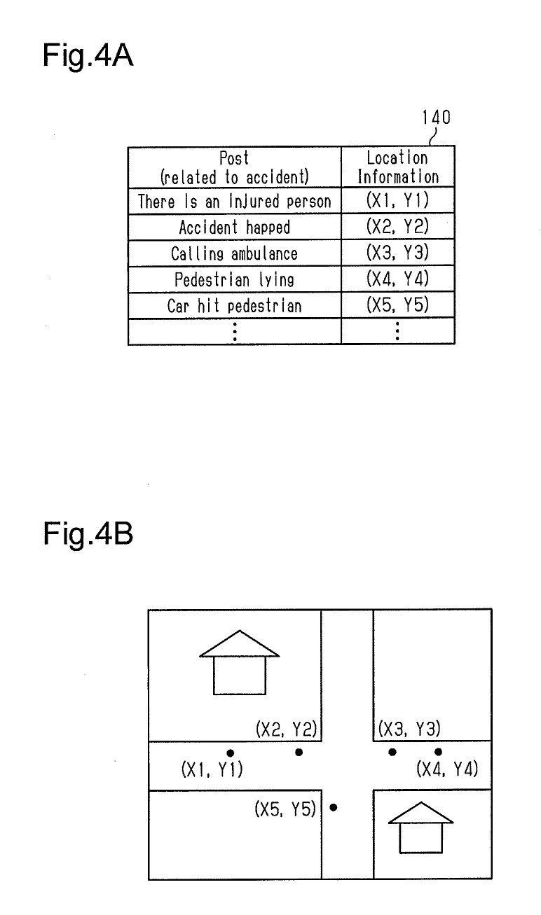

The location information setting section 114 associates the post including the accident information extracted by the post extracting section 111 with the location information about the first vehicle 400 received from the first in-vehicle unit 410 by the location information requesting section 112, and stores these in the accident information database 140. In the example shown in FIGS. 4A and 4B, the accident information database 140 stores multiple posts related to an accident that have been uploaded by occupants of vehicles stopped at several points at the same intersection. At this time, the positions of the respective vehicles are within a range of a predetermined distance.

The traffic information delivering section 115 reads out the location information about the first vehicle 400 stored in the accident information database 140 as the location information about the poster of the post associated with the location information about the first vehicle 400. In addition, the traffic information delivering section 115 delivers the read out location information about the poster to a second in-vehicle unit 510 mounted on a second vehicle 500 in association with the accident information included in the post. At this time, the traffic information delivering section 115 compares the posting locations of the multiple posts read out from the accident information database 140 with each other and determines that the posting locations of the posts within the range of the predetermined distance are the posting locations of the posts associated with the same point. Then, the traffic information delivering section 115 delivers the accident information included in the posts to the second in-vehicle unit 510 in association with the location information about a condition that the number of the posts associated with the same point is greater than or equal to a predetermined threshold value.

Next, the delivery process of accident information executed by the information providing server 100 of the present embodiment will be described.

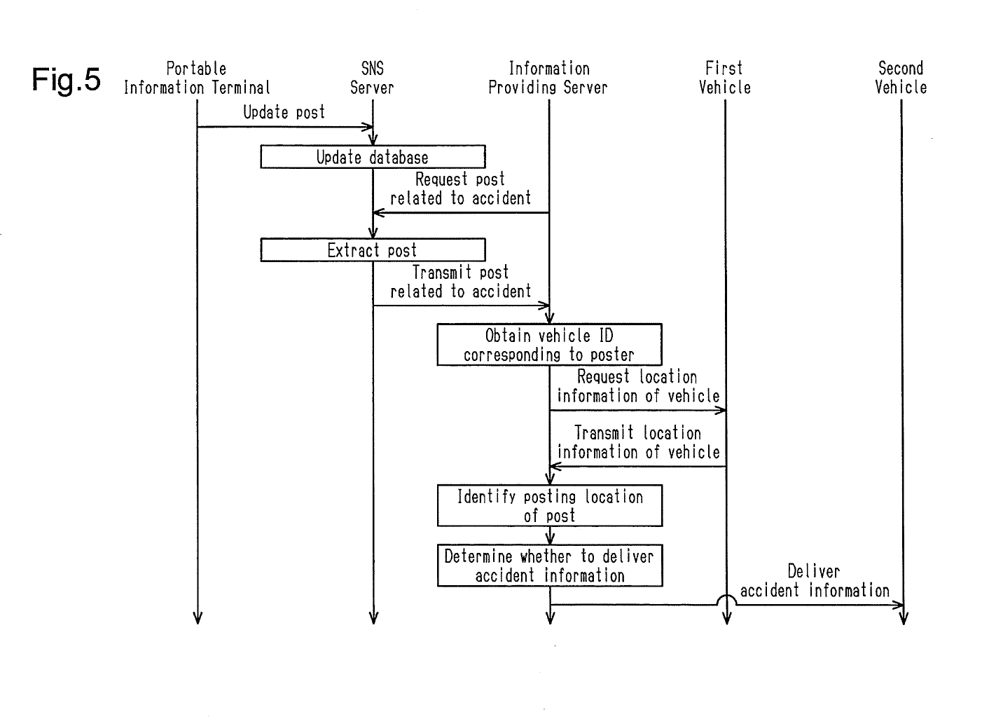

As shown in FIG. 5, the portable information terminal 300 first uploads a post to the SNS server 200 by accepting a text input operation by the user with the application related to the SNS activated.

Upon receiving the post uploaded from the portable information terminal 300, the SNS server 200 updates the database by adding the received post to the database.

The information providing server 100 periodically requests posts related to accidents from the SNS server 200.

Upon receiving a request for a post from the information providing server 100, the SNS server 200 extracts a post including a keyword related to accidents from the posts accumulated in the database. Then, the SNS server 200 transmits the extracted posts related to the accident to the information providing server 100.

Upon receiving the posts related to the accident from the SNS server 200, the information providing server 100 extracts the user IDs associated with the received posts. Further, the information providing server 100 refers to the user information database 130 to obtain the vehicle IDs corresponding to the posters. Then, the information providing server 100 requests the vehicle location information from the first vehicle 400 corresponding to the vehicle ID.

Upon receiving the request for the vehicle location information from the information providing server 100, the first vehicle 400 detects the vehicle location information through the GPS device mounted on the first vehicle 400. The first vehicle 400 transmits the detected vehicle location information to the information providing server 100.

Upon receiving the vehicle location information from the first vehicle 400, the information providing server 100 identifies the posting location of the post based on the received vehicle location information. In addition, the information providing server 100 refers to the accident information database 140 to read out accident information corresponding to the posting location identified earlier. Then, the information providing server 100 determines whether to deliver the accident information based on whether the accident information read out from the accident information database 140 satisfies a predetermined delivery condition. The predetermined delivery condition includes checking if the number of posts associated with the same point is greater than or equal to a predetermined threshold value. When determining that the accident information read out from the accident information database 140 satisfies the predetermined delivery condition, the information providing server 100 associates the accident information with the location information and delivers it to the second vehicle 500. At this time, the second vehicle 500 associates the accident information delivered from the information providing server 100 with a position on the map data and presents it to the user via the second in-vehicle unit 510.

Next, an operation of the information providing server 100 of the present embodiment will be described.

In recent years, there are many people who upload traffic information about traffic accidents and the like to an SNS server such as the SNS server 200, so that traffic information tends to gather quickly on the SNS server 200. Therefore, the posts accumulated in the SNS server 200 can be useful information for analysis of traffic information. However, since the posts uploaded to the SNS server 200 are short sentences, they often lack information about the exact locations where posts were uploaded. Also, from the viewpoint of protection of privacy, many users do not disclose, to the outside, the information about the locations where posts are uploaded.

In this regard, the information providing server 100 of the present embodiment obtains the vehicle ID corresponding to the poster even if the location information about the poster is not included in the post, thereby identifying, as the location information about the poster, the vehicle location information received from the first vehicle 400 corresponding to the obtained vehicle ID. Therefore, the posting location of the post including traffic information is identified with high versatility.

As described above, the above described embodiment has the following advantages.

(1) Even if a post does not include the poster's location information, the information providing server 100 can identify the location where a post including traffic information based on the poster's location information received from the first in-vehicle unit 410 associated with the poster.

(2) The information providing server 100 delivers the accident information included in the post to the second in-vehicle unit 510 based on verification of a condition that the number of the posts associated with the same point is greater than or equal to the predetermined threshold value. Therefore, it is possible to identify the location information uploaded with high reliability.

(3) The first vehicle 400, which is the transmission source of the poster's location information, is different from the second vehicle 500, which is the delivery destination of the traffic information with which the location information is associated. This increases the versatility of delivery of the post including the traffic information to the user.

(4) Since the user ID of the SNS is associated with the vehicle ID, the first vehicle 400, on which the poster of the post is riding, is identified. This allows the vehicle location information to be detected as the location information about the poster by means of the GPS device mounted on the first vehicle 400.

The above illustrated embodiment may be modified as follows.

In the above-described embodiment, the information providing server 100 obtains the vehicle ID corresponding to the poster of a post based on the user ID associated with the post. Then, the first vehicle 400 corresponding to the vehicle ID is identified as the vehicle that is the transmission source of the poster's location information (the vehicle from which the information is requested). However, the method of identifying the vehicle from which the poster's location information is requested is not limited to this. For example, the information providing server 100 may identify the vehicle from which the location information about the poster is requested by comparing the history information about the posting location of the post from the portable information terminal 300 at the same hour of the day with the history information about the traveling positions of the vehicle.

In the above-described embodiment, the vehicle that is the transmission source of the poster's location information is different from the vehicle that is the delivery destination of the traffic information with which the location information is associated. However, the vehicle that is the transmission source of the poster's location information may be the same as the vehicle that is the delivery destination of the traffic information with which the location information is associated.

In the above-described embodiment, the information providing server 100 delivers the accident information included in the post to the second in-vehicle unit 510 based on verification of a condition that the number of the posts associated with the same point is greater than or equal to the predetermined threshold value. However, the delivery condition for traffic information is not limited to this, and whether to deliver traffic information may be determined in consideration of, for example, the degree of density of posting locations of posts and posting time (freshness of information). Also, even if the number of posts including accident information associated with the same point is greater than or equal to the threshold value, the information providing server 100 may determine that the accident information is remotely related to the traveling of vehicle when receiving no location information from vehicles at that point. In that case, the information providing server 100 excludes that accident information from information to be delivered to the vehicle. In addition, the information providing server 100 may be configured to deliver only accident information located within a range of a predetermined distance from the current location of the vehicle to which information is to be delivered and accident information located on the route to the destination of the vehicle.

The above-described embodiment presents a case in which the traffic information to be delivered is accident information. However, the traffic information to be delivered does not necessarily need to be accident information. For example, the information to be delivered may be congestion information, roadwork information, and the like.

The apparatuses, units, modules, devices, and other components illustrated in FIG. 1 that perform the operations described herein with respect to FIG. 5 are implemented by hardware components. Examples of hardware components include controllers, sensors, generators, drivers, and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIG. 5. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIG. 1 that perform the operations described herein with respect to FIG. 5 are performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMS, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A traffic information providing system comprising a processor, the processor comprising:
a post extracting section configured to extract a post including traffic information from among posts accumulated in an SNS server;
a location information requesting section configured to request, from a first in-vehicle unit associated with a poster of the post extracted by the post extracting section, location information of the poster;
a location information obtaining section configured to obtain the location information of posters transmitted from the first in-vehicle unit in response to a request from the location information requesting section;
a location information setting section configured to associate the location information of the poster obtained by the location information obtaining section with the traffic information included in the post; and
a traffic information delivering section configured to deliver the traffic information, with which the location information of the poster is associated by the location information setting section, either to the first in-vehicle unit or a second in-vehicle unit different from the first in-vehicle unit.

2. The traffic information providing system according to claim 1, wherein the traffic information delivering section is configured to deliver the traffic information included in the post either to the first in-vehicle unit or the second in-vehicle unit based on verification of a condition that the number of posts associated with the same point is greater than or equal to a predetermined threshold value.

3. The traffic information providing system according to claim 1, wherein the first in-vehicle unit and the second in-vehicle unit are mounted in different vehicles.

4. The traffic information providing system according to claim 1, further comprising a memory section configured to store a user ID of an SNS and a vehicle ID while associating the IDs with each other, and
wherein the location information requesting section is configured to,
based on a user ID related to the poster of the post extracted by the post extracting section, read out a corresponding vehicle ID by referring to the memory section, and
based on the read out vehicle ID, identify the first in-vehicle unit that is a source of transmission of the location information of the poster.

5. A traffic information providing method of providing traffic information by a processor, the traffic information providing method comprising:
extracting a post including traffic information from posts accumulated in an SNS server, being associated;
associating a first in-vehicle unit with a poster of the extracted post;
requesting location information of the poster from the first in-vehicle unit;
obtaining the location information of the poster transmitted from the first in-vehicle unit in response to the request for the location information of the poster;
associating the obtained location information of the poster with the traffic information included in the post; and
delivering the traffic information, with which the location information of the poster is associated, either to the first in-vehicle unit or a second in-vehicle unit different from the first in-vehicle unit.

6. A non-transitory computer readable memory medium storing a program that causes a processor to perform a traffic information providing process of providing traffic information, wherein the traffic information providing process comprises:
extracting a post including traffic information from posts accumulated in an SNS server;
associating a first in-vehicle unit with a poster of the extracted post;
requesting location information of the poster from the first in-vehicle unit,
obtaining the location information about the poster transmitted from the first in-vehicle unit in response to the request for the location information of the poster;
associating the obtained location information of the poster with the traffic information included in the post; and
delivering the traffic information, with which the location information of the poster is associated, either to the first in-vehicle unit or a second in-vehicle unit different from the first in-vehicle unit.
